(19) United States
(12) Patent Application Publication
(10) Pub. No.: US 2013/0020161 A1
(43) Pub. Date: Jan. 24, 2013

(54) POWER SUPPLY AND ACQUISITION APPARATUS FOR ON-LINE ELECTRIC VEHICLE

(71) Applicants: Nam Pyo Suh, Daejeon (KR); Soon Heung Chang, Daejeon (KR); Dong Ho Cho, Seoul (KR); Gyu Hyeong Cho, Daejeon (KR); Chun Taek Rim, Daejeon (KR); Jung Goo Cho, Suwon (KR); Joung Ho Kim, Daejeon (KR)

(72) Inventors: Nam Pyo Suh, Daejeon (KR); Soon Heung Chang, Daejeon (KR); Dong Ho Cho, Seoul (KR); Gyu Hyeong Cho, Daejeon (KR); Chun Taek Rim, Daejeon (KR); Jung Goo Cho, Suwon (KR); Joung Ho Kim, Daejeon (KR)

(73) Assignee: KOREA ADVANCED INSTITUTE OF SCIENCE AND TECHNOLOG, DAEJEON (KR)

(21) Appl. No.: 13/391,027

(22) PCT Filed: Sep. 17, 2010
(86) PCT No.: PCT/KR10/06453

§ 371 Date: Oct. 9, 2012

(30) Foreign Application Priority Data
Sep. 19, 2009 (KR) 10-2009-0088773

(51) Int. Cl. B60L 9/00; H02J 17/00

(52) U.S. Cl. 191/10

(57) ABSTRACT

A power supply and acquisition apparatus for an electrical vehicle includes a power supply device embedded along a road and a power acquisition device attached on the vehicle. The power supply device includes a plurality of power supply core units, each core unit having two opposite magnetic poles and formed in a direction perpendicular to a longitudinal direction of the road; and one or more power supply lines disposed along the longitudinal direction such that adjacent two magnetic poles have different polarities. The power acquisition device includes power acquisition core units; a connection member for connecting the power acquisition core units such that the power acquisition core units are spaced from each other by a distance between the magnetic poles; and a power acquisition coil wound around the respective power acquisition core units or the connection member.

### TECHNICAL FIELD

The present invention relates to a non-contact power supply and acquisition apparatus for an on-line electric vehicle, and more particularly, to a power supply and acquisition apparatus for such an on-line electric vehicle, which allows a large air gap between a power acquisition device and a power supply device and allows a sufficient permissible range of a steering deviation.

### BACKGROUND ART

Existing battery-powered electric vehicles have problems such as an excessive capacity, a long charging time, low charging efficiency and a short lifetime of batteries, a request for a charging station, and an increase in weight or volume and cost of the vehicles due to such batteries.

In order to solve the above problems, there has been proposed a non-contact power delivery scheme using magnetic induction. In particular, one example of the non-contact power delivery scheme includes a power supply and acquisition apparatus for an on-line electric vehicle, which has been developed by the assignee of the present application, Korea Advanced Institute of Science and Technology (KAIST). The power supply and acquisition apparatus includes a power supply device embedded along a road and a power acquisition device installed on the on-line electric vehicle, which is capable of supplying a power required for the vehicle from the road, and charges a battery with the power, while being driven.

The on-line electric vehicle requires a structure capable of normally delivering power, even though a distance between a power acquisition device and the road surface, that is, an air gap is increased. Furthermore, in order to allow the on-line electric vehicle to travel along the road, power acquisition needs to be smoothly performed, even though the on-line electric vehicle deviates from the center of the power supply device embedded in the road and moves more or less in the left or right

FIG. 1 illustrates an exemplary power supply and acquisition apparatus for an on-line electric vehicle. The apparatus includes an E-shaped power supply device 110 embedded along a road and a power acquisition device 120 installed on the on-line electric vehicle 130. The power supply device 110 includes a power supply core unit 111 and power supply lines 113. The power supply core unit 111 includes three magnetic poles 112 upwardly formed in a direction perpendicular to the traveling direction of the electric vehicle. The power acquisition device 120 is typically attached under the electric vehicle 130, and includes a power acquisition core unit 121 and a power acquisition coil 123. The power acquisition core unit 121 has three magnetic poles 122 opposite to the three magnetic poles 112, respectively. In the power supply and acquisition apparatus, the distribution of magnetic force lines is the same anywhere in the longitudinal direction of the road. Furthermore, a voltage induced in the power acquisition device 120 has the same as that induced when the electric vehicle 130 is stopped as well as being driven.

Based on such a principle, for example, the PATH (Partners for Advanced Transit and Highways) team led by University of California at Berkeley has developed a non-contact power delivery technology since from 1988. In the non-contact power delivery technology, an air gap of 2-3 inch (about 5-7.5 cm) could be realized, and power could be transferred even though a vehicle is deviated about 15 cm in the left or right.

In addition, Bombardier Inc. of Germany, headquartered in Canada, has applied a non-contact power delivery technology to a railway vehicle, and it is reported that an air gap of about 6 cm has been realized. In the railway vehicle, since left and right steering is not required, no deviation occurs in the left and right direction. Therefore, the width of the power supply device could be reduced to about 15 cm, and system power efficiency has been increased to about 92% or more.

FIGS. 2 and 3 respectively show a front view and a plan view of a monorail power supply and acquisition apparatus; and FIGS. 4 and 5 respectively show a front view and a plan view of a dual-rail power supply and acquisition apparatus.

In FIGS. 2 and 3, the monorail power supply and acquisition apparatus includes a power supply device 210 embedded along a road and a power acquisition device 220 installed on an on-line electric vehicle. The power supply device 210 includes an E-shaped power supply core unit 211 and a power supply line 212; and the power acquisition device 220 includes a flat power acquisition unit 213 and a power acquisition coil 214. Similarly, In FIGS. 4 and 5, the dual-rail power supply and acquisition apparatus includes a power supply device 230 embedded along a road and a power acquisition device 240 installed on an on-line electric vehicle. The power supply device 230 includes two E-shaped power supply core units 231 and two power supply lines 232; and the power acquisition device 240 includes a flat power acquisition unit 233 and two power acquisition coils 234. In this connection, one power supply line defines a monorail and two power supply lines define a dual-rail.

One example of a power supply and acquisition apparatus is disclosed in a PCT application PCT/KR2010/000856, filed on Feb. 11, 2010, entitled POWER SUPPLY DEVICE, POWER ACQUISITION DEVICE AND SAFETY SYSTEM FOR ELECTROMAGNETIC INDUCTION-POWERED ELECTRIC VEHICLE, which is assigned to the assignee of the present application.

On June and August, 2009, the assignee of the present application has accomplished a system power efficiency of about 70% or more while increasing an air gap to about 16 cm or more by using the power supply acquisition apparatus as shown in FIGS. 2 to 5. Considering a depth at which the power supply device is embedded in the road, an air gap of about 20 cm has been accomplished. Furthermore, the permissible amount of the left and right deviation in the power supply and acquisition apparatus ranges from about 20 to 40 cm. Accordingly, it is expected that the power supply and acquisition apparatus is highly likely to be put to practical use.

However, in the power supply and acquisition apparatus, there exists a problem in that the width of a power supply rail should be about two times larger than a desired air gap. For example, given the desired air gap of 25 cm, the width of the power supply rail should be about 50 cm. In the case of the monorail power supply and acquisition apparatus shown in FIGS. 2 and 3, the width of the power supply device 210 is the same as that of the power supply rail. In the case of the dual-rail power supply and acquisition apparatus shown in FIGS. 4 and 5, however, the width of the power supply device 231 is two times larger than that of the power supply rail. As such, if the width of the power supply device is excessively increased, the material cost of the core unit and a road building cost may increase. Further, the intensity of the electromagnetic field (EMF) in a lateral of the vehicle may also increase, and thus, it is not easy to satisfy a permissible reference value (62.5 mG or less in a band of 20 kHz).

On the contrary, if the width of the power supply rail is reduced to 30 cm or less, a magnetic field from one magnetic pole of the power supply device tends to immediately enter another magnetic pole.

Furthermore, in the power supply and acquisition apparatus, as the air gap is increased, the width of the acquisition device should also be increased. The width of the power acquisition device should not only be increased more than the width of the power supply device by the air gap, but also a permissible value of the steering deviation in the left and right direction of the vehicle should also be added to the increased width. For example, given that the air gap is 25 cm and the steering deviation is 30 cm, the width of the power supply device of the dual rail approaches 210 cm (=25 cm (air gap)×2(two times)×2 (dual rail)+25 cm (air gap)×2 (left/right)+30 cm (steering deviation)×2 (left/right)). The width amounts to the overall width of a typical bus, and a passenger car does not satisfy such a condition.

### DISCLOSURE OF INVENTION

### Technical Problem

In view of the above, the present invention provides a power supply and acquisition apparatus for an on-line electric vehicle, which allows a large air gap between a power acquisition device and a power supply device and allows a sufficient permissible range of a steering deviation.

Further, the present invention provides a power supply and acquisition apparatus for an on-line electric vehicle, which significantly reduces electromagnetic field (EMF) generated therefrom.

### Solution to Problem

In accordance with a first aspect of the present invention, there is provided a power supply device which supplies power to an electric vehicle using a magnetic induction, the power supply device including:

a plurality of power supply core units embedded along a road, each core unit having two magnetic poles spaced from each other and formed in a direction perpendicular to a longitudinal direction of the road; and

one or more power supply lines disposed along the longitudinal direction such that adjacent two magnetic poles of the power supply core units have different polarities.

In the power supply device, if two power supply lines is provided, the two power supply lines have opposite current directions.

In the power supply device, the power supply lines are covered by a magnetic material.

In the power supply device, one of the power supply lines is extended along one of the magnetic poles of the respective power supply core units and the other power supply line is extended along the other magnetic pole of the respective power supply core units to alternately generate magnetic force lines of different poles in the respective magnetic poles.

In the power supply device, a distance between the two power supply lines is minimized in such a manner that electric field generated in a lateral of the road is minimized.

In the power supply device, the power supply lines connect one end of one of the magnetic poles and the other end of the other magnetic pole of the respective power supply core units in a diagonal direction.

In the power supply device, the one or more power supply lines are wound by several turns around adjacent two magnetic poles of adjacent power supply core units.

In the power supply device, a line-shaped magnetism shielding member is further provided along the power supply device.

In accordance with a second aspect of the present invention, there is provided a power acquisition device for an electrical vehicle, which acquires power from a power supply device using a magnetic induction, the power acquisition device including:

two or more power acquisition core units installed in the electrical vehicle and spaced from the power supply device;

a connection member for connecting the power acquisition core units such that the power acquisition core units are spaced from each other by a distance between magnetic poles of the power supply device; and

a power acquisition coil wound around the respective power acquisition core units or the connection member.

In the power acquisition device, the power acquisition core units are formed in a plate type.

In the power acquisition device, the power acquisition core units are formed in a lattice type.

In the power acquisition device, a loop-shaped magnetism shielding member is further installed around the power acquisition core units.

In accordance with a third aspect of the present invention, there is provided a power supply and acquisition apparatus for an electrical vehicle, including:

a power supply device, the power supply device including a plurality of power supply core units embedded along a road, each core unit having two magnetic poles spaced from each other and formed in a direction perpendicular to a longitudinal direction of the road; and one or more power supply lines disposed along the longitudinal direction such that adjacent two magnetic poles of the power supply core units have different polarities; and

a power acquisition device, the power acquisition device including two or more power acquisition core units installed in the electrical vehicle and spaced at a predetermined distance from the power supply device; a connection member for connecting the power acquisition core units such that the power acquisition core units are spaced from each other by a distance between magnetic poles of the power supply device; and a power acquisition coil wound around the respective power acquisition core units or the connection member.

### Advantageous Effects of Invention

In accordance with the embodiments of the present invention, a plurality of power supply core units are arranged in perpendicular direction to a traveling direction of a vehicle on a road. Accordingly, it is sufficient to increase a pole gap between the magnetic poles in order to increase an air gap between the power acquisition device and the surface of a road, without increasing the width of the power supply device.

Further, the power supply and acquisition apparatus allows a large steering deviation even though the vehicle leans to the right or left direction resulting in an increased steering deviation, and has an advantage in that the EMF generated in a lateral of the road is reduced.

### BRIEF DESCRIPTION OF DRAWINGS

The above and other objects and features of the present invention will become apparent from the following description of embodiments given in conjunction with the accompanying drawings, in which:

FIG. 1 illustrates a power supply and acquisition apparatus for an on-line electric vehicle;

FIGS. 2 and 3 respectively illustrate a front view and a plan view of a monorail power supply and acquisition apparatus;

FIGS. 4 and 5 respectively illustrate a front view and a plan view of a dual-rail power supply and acquisition apparatus;

FIGS. 6 and 7 respectively illustrate a plan view and a side view of a dual-rail power supply and acquisition apparatus in accordance with an embodiment of the present invention;

FIGS. 8 and 9 respectively illustrate a plan view and a side view of a monorail power supply and acquisition apparatus in accordance with another embodiment of the present invention;

FIGS. 10 and 11 respectively illustrate a plan view and a side view of a Z-shaped power supply device in accordance with another embodiment of the present invention;

FIGS. 12 and 13 respectively illustrate a plan view and a side view of a Z-shaped power supply device, respectively, in accordance with another embodiment of the present invention;

FIG. 14 is a graph showing how an effective value of an acquired voltage changes at each position when the power acquisition device passes over the Z-shape power supply device;

FIGS. 15, 16 and 17 respectively illustrate a plan view, a side view, and a front view of a dual-rail power supply and acquisition apparatus in accordance with another embodiment of the present invention; and

FIGS. 18, 19 and 20 respectively illustrate a plan view, a side view, and a front view of a dual-rail power supply and acquisition apparatus, in which a Z-shaped power supply device and a power acquisition device are magnetically shielded.

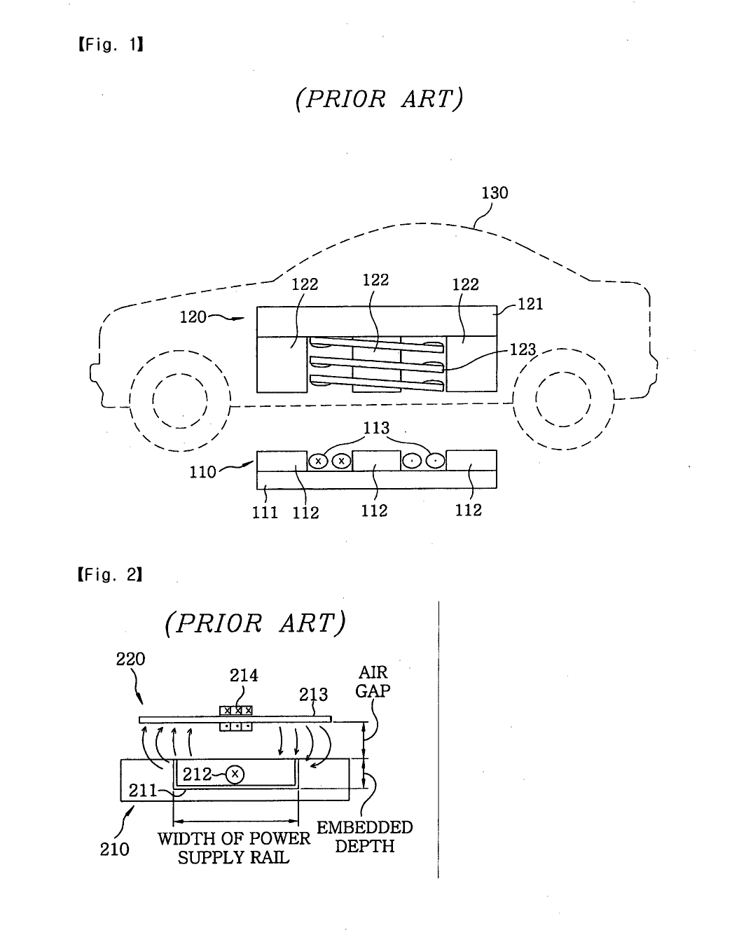

### BEST MODE FOR CARRYING OUT THE INVENTION

Hereinafter, embodiments of the present invention will be described in detail with reference to the accompanying drawings so that they can be readily implemented by those skilled in the art. In the accompanying figures, like reference numerals refer to identical or functionally similar elements throughout the separate views.

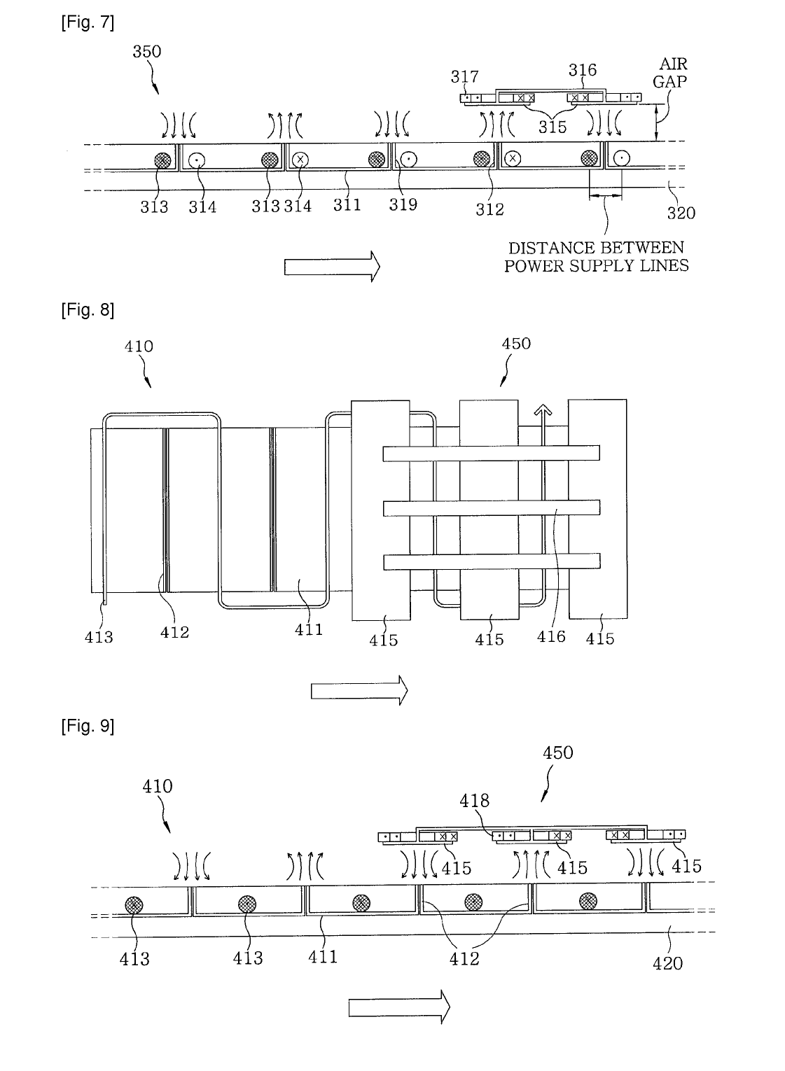

FIGS. 6 and 7 respectively illustrate a plan view and a side view of a dual-rail power supply and acquisition apparatus in accordance with an embodiment of the present invention. The dual-rail power supply and acquisition apparatus includes a Z-shaped power supply device 310 embedded in a road 320 and a power acquisition device 350 installed on the on-line electric vehicle. The Z-shaped power supply device 310 includes a plurality of power supply core units 311 embedded along the road 320 and two power supply lines 313 and 314.

Each power supply core unit 311 has a U-shape which is constructed by bending upward both end portions of a flat power supply core unit. In the U-shaped power supply core unit 311, both upright end portions serve as magnetic poles 312 and 319. Accordingly, the U-shaped power supply core unit 311 has a pair of magnetic poles 312 and 319 opposite to each other arranged in a direction perpendicular to a traveling direction of the vehicle as indicated an arrow in FIGS. 6 and 7.

The power supply lines 313 and 314 are arranged in the power supply core units 311 in Z-fashion or zig-zag fashion. To be more specific, a first power supply line 313 is extended along a first magnetic pole 312 of the respective power supply core units 311 in Z-fashion and a second power supply line 314 is extended along a second magnetic pole 319 of the respective power supply core units 311 in Z-fashion to alternately generate magnetic force lines of N and S poles in the respective magnetic poles 312 and 319.

In a dual-rail power supply and acquisition apparatus as shown in FIGS. 6 and 7, currents in the two power supply lines 313 and 314 flow in the opposite directions and the magnetic field is generated in parallel to the traveling direction.

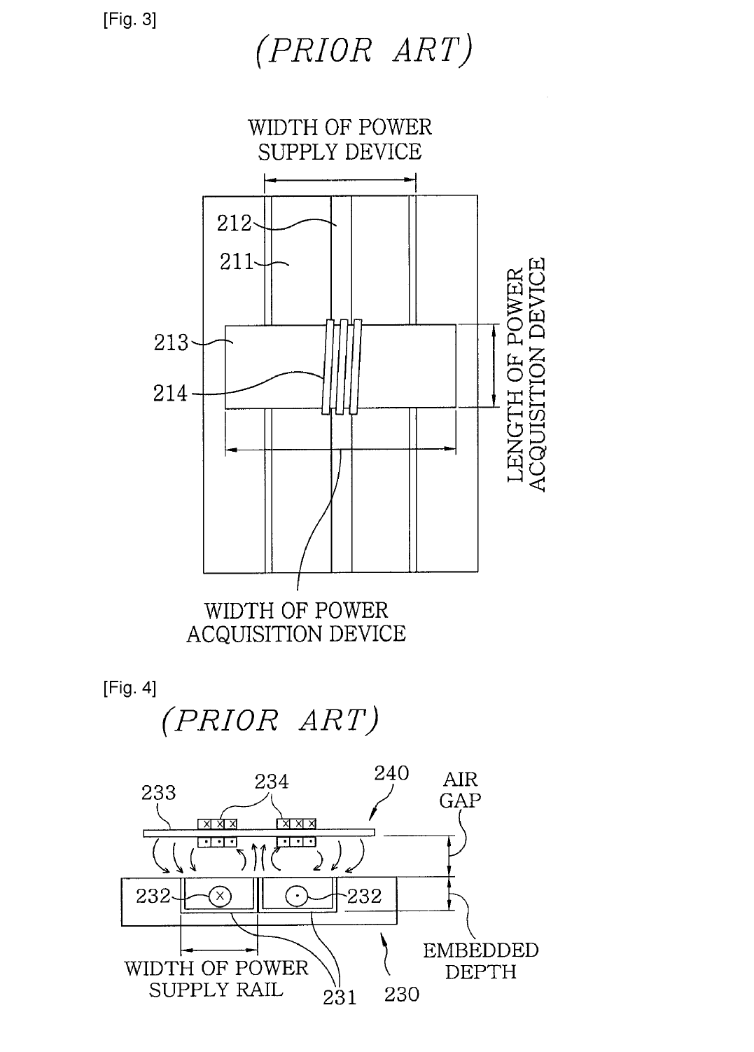

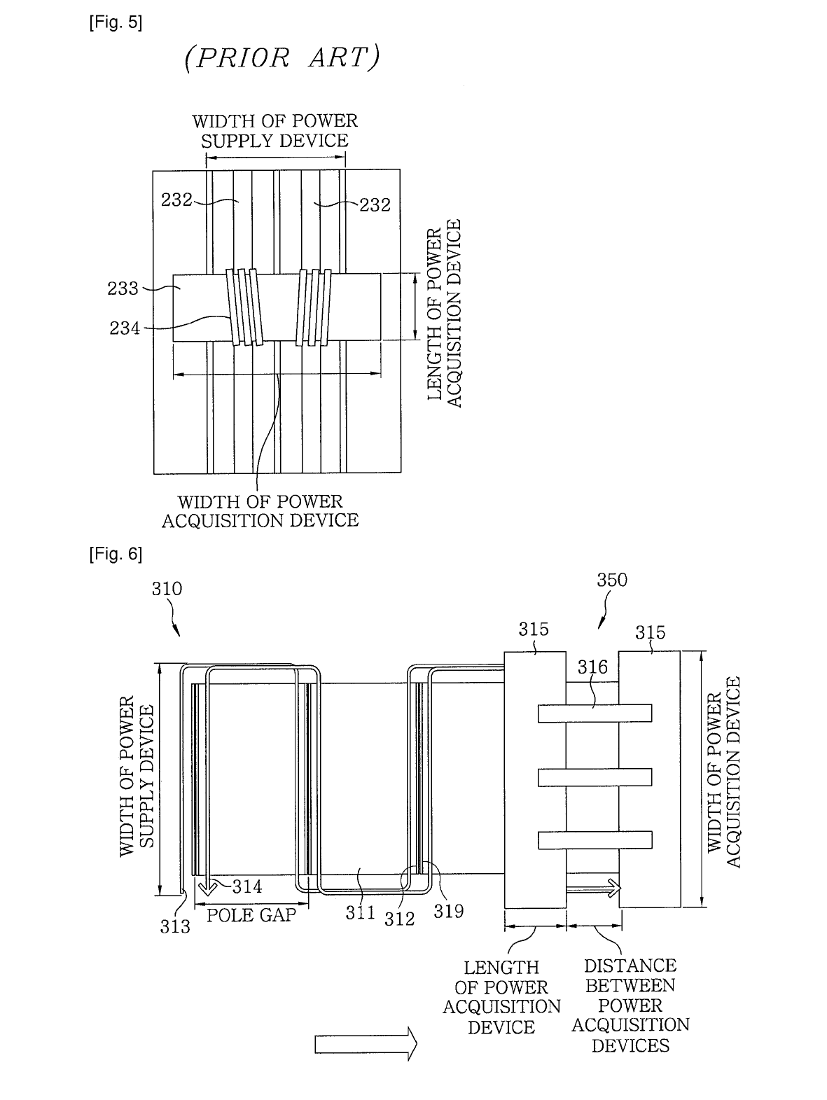

As the power supply core units 311 are arranged in perpendicular direction to the road, increasing a pole gap between the magnetic poles 313 and 314 results in an increase of an air gap between the power acquisition device and the surface of a road. For example, if a power supply core unit as shown in FIGS. 2 to 5 is arranged along the traveling direction of the vehicle, the width of a power supply device needs to be increased to extend the air gap. However, the embodiment as shown in FIGS. 6 and 7 requires increasing only a pole gap between two magnetic poles 312 and 319 in order to extend the air gap, without increasing the width of the power supply device. Accordingly, a material cost of the power supply core unit or a road building cost does not increase.

Further, the embodiment of the power supply and acquisition apparatus allows a large steering deviation. That is, if the width of the power acquisition device 350 is set to be larger than that of the power supply device 310, there is no large change in delivered power, as long as the resistance of the magnetic circuit is constantly maintained even though the vehicle leans to the right or left direction resulting in an increased steering deviation.

In this embodiment, for example, given that the pole gap ranges from about 30 to 50 cm, the height of the magnetic poles 312 and 319 of the power supply core unit 311 may be preferably set in the range of about 10 to 15 cm. If the height of the magnetic poles 312 and 319 is too small, the intensity of the magnetic field becomes weak; if, however, the height of the magnetic pole 312 and 319 is too large, a magnetic leakage flux may increase, which decreases the degree of combination with the power acquisition device 350.

Furthermore, in this embodiment, the distance between the two power supply lines 313 and 314 with the interposed magnetic poles is preferably set to be as small as possible. As the distance between the power supply lines is reduced, the intensity of the magnetic field from the magnetic poles 312 and 319 of the power supply core unit 311 becomes weak. On the contrary, a distance at which the two power supply lines 313 and 314 pass along an outside of the power supply core unit 311 increases, and the amount of EMF generated in the lateral direction of the road decreases due to the offset caused by the superposition of the opposite magnetic fields.

Alternatively, two power supply lines may be positioned in the center of a power supply core unit 311 by increasing the distance between the power supply lines. Then, it is possible to considerably increase the intensity of the magnetic field of the power supply core unit 311. In this case, a large EMF may be generated because the power supply lines pass along the outside of the power supply core units. In order to overcome the above problem, a magnetism shielding may be applied. For example, the power supply lines may be covered with a magnetic material. Alternatively, the power supply lines may be arranged inside the power supply core unit so as not to deviate from the power supply core unit.

Meanwhile, the power acquisition device 350 includes a plurality of power acquisition core units 315 disposed in the widthwise direction of the road 320 and a connection member 316 connecting the power acquisition core units 315. A power acquisition coil 317 is wound around the power acquisition core units 315 or the connection member 316 which forms a magnetic path. The power acquisition is connected to batteries of the electric vehicle for charging. FIGS. 6 and 7 shows an example in which two power acquisition devices are provided, but three or more power acquisition devices may be provided.

The connection member 316 connects the power acquisition core units 315 such that the power acquisition core units 315 are spaced from each other by a distance between the two opposite magnetic poles 312 and 319 of the power supply core units 311.

FIGS. 8 and 9 respectively illustrate a plan view and a side view of a monorail power supply and acquisition apparatus in accordance with another embodiment of the present invention.

The monorail power supply and acquisition apparatus includes a Z-shaped power supply device 410 embedded in a road 420 and a power acquisition device 450 installed on an on-line electric vehicle. The Z-shaped power supply device 410 includes a plurality of U-shaped power supply core units 411 embedded along the road 420 in a direction perpendicular to a traveling direction of the vehicle as indicated an arrow in FIGS. 8 and 9 and a power supply line 413. The power acquisition device 450 includes a plurality of power acquisition core units 415 disposed in the widthwise direction of the road 420 and a connection member 416 connecting the power acquisition core units 415.

In this embodiment, as shown in FIGS. 8 and 9, the power supply line 413 is not necessarily arranged in such a manner as to pass the center of a power supply core unit 411 or between two magnetic poles 412. Further, in this embodiment, three power acquisition devices 415 are provided instead of two power acquisition devices as shown in FIGS. 6 and 7. As the number of power acquisition devices increases, it is possible to acquire a larger amount of power. For example, several power acquisition devices may be included in correspondence to the overall length of the vehicle.

Further, the embodiment of FIGS. 8 and 9 shows an example in which three power acquisition coils 418 wounded on the power acquisition core units 415, respectively. Alternatively, it may be possible to arrange such that only one power acquisition coil is wounded on a center power acquisition core unit, and remaining two power supply core units are provided in the front and rear side of the center power acquisition core units without having power acquisition coils. In this configuration, the power supply core units 415 in the front and rear side serve only as magnetic circuits, and does not delivery power.

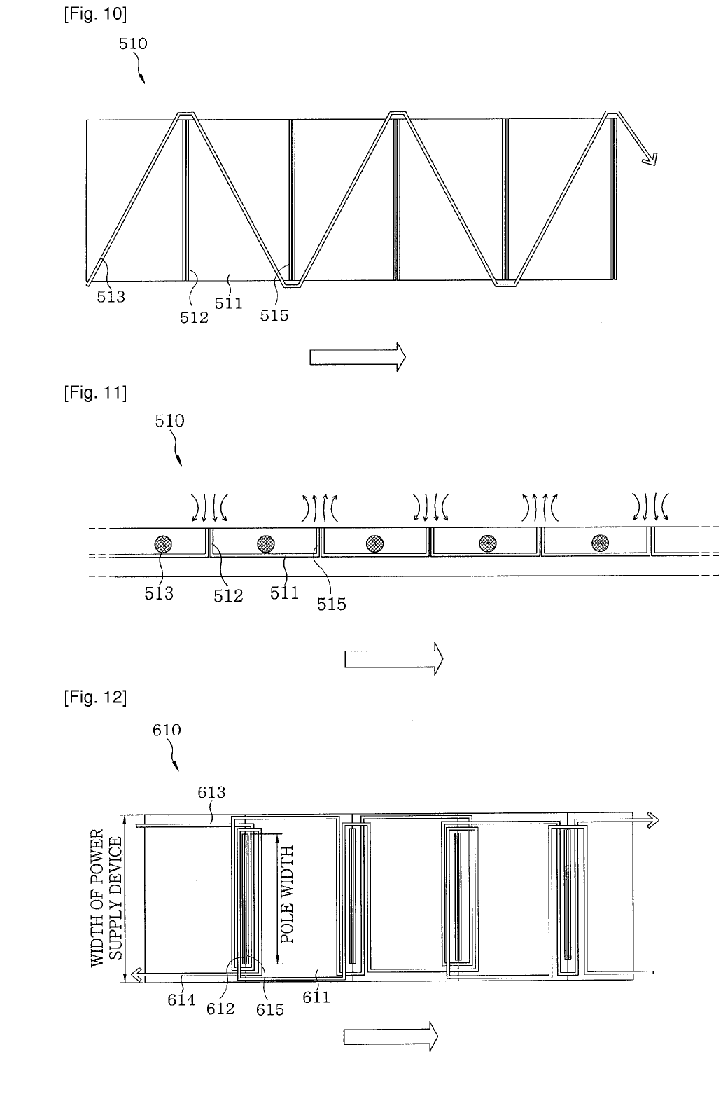

FIGS. 10 and 11 respectively illustrate a plan view and a side view of a Z-shaped power supply device, in accordance with another embodiment of the present invention.

Similar to the embodiments as set forth above, the Z-shaped power supply device 510 includes a plurality of U-shaped power supply core units 511 embedded along a road in a direction perpendicular to a traveling direction of the vehicle as indicated an arrow in FIGS. 10 and 11 and a power supply line 513. In this embodiment, one end of a magnetic pole 512 and the other end of an opposite magnetic pole 515 in a U-shaped power supply core unit 511 are connected by a power supply line 513 in a diagonal direction. Therefore, it is possible to minimize the length of the power supply line 513 as much as possible.

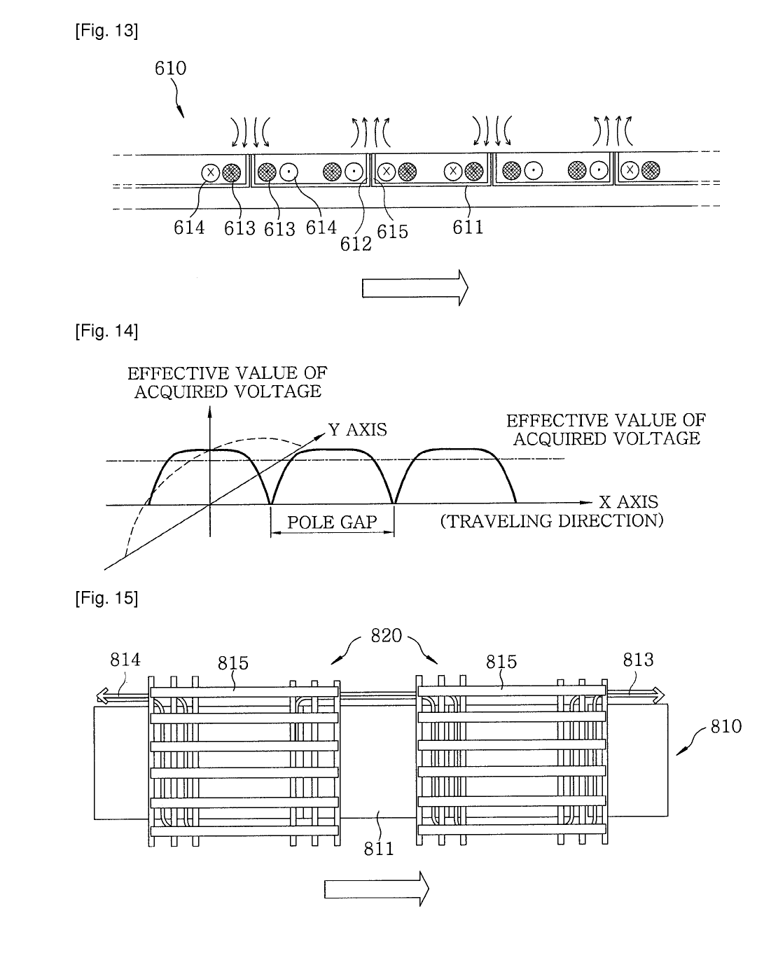

FIGS. 12 and 13 respectively illustrate a plan view and a side view of a Z-shaped power supply device in accordance with another embodiment of the present invention.

Similar to the embodiments as set forth above, the Z-shaped power supply device 610 includes a plurality of U-shaped power supply core units 611 embedded along a road in a direction perpendicular to a traveling direction of the vehicle as indicated an arrow in FIGS. 12 and 13 and a power supply line 513.

In this embodiment, each of power supply lines 613 and 614 is wound by several turns around adjacent magnetic poles 612 and 615 of the adjacent power supply core units 611, by which it is possible to increase the magnetic field intensity of the magnetic poles 612 and 615.

Further, in this embodiment, the width of the magnetic poles 612 and 615 is smaller than that of a power supply device 610. According to this configuration, although the power supply lines 613 and 614 pass along side edges of the power supply core unit 611, a magnetic field generated in the edges can be absorbed by the power supply device itself.

Alternatively, the two power supply lines 613 and 614 may be provided so as to pass through the same position in the power supply core unit. Then, a magnetic field may also be absorbed effectively by the power supply device itself.

FIG. 14 is a graph showing how an effective value of an acquired voltage changes at each position when the power acquisition device passes over the Z-shape power supply device. The acquired voltage drops to zero at every pole gap in the traveling direction (i.e., x-axis) of the vehicle. Thus, it is important to design the power acquisition device in such a manner that the effective values of the collecting voltage exhibit as a wide flat portion as possible. By doing so, the average value of the effective values increases, and thus the amount of the power delivery increases. Such a variation in the collecting voltage may be buffered by incorporating a regulator in the power acquisition device. Therefore, the variation may not be a big problem for practical use. In a case that a plurality of power acquisition devices is used, the respective acquisition devices may be arranged so as to deviate from each other by ½ or ⅓ of the pole gap. Furthermore, the maximum voltages of the respective acquisition devices may be selected by the regulator, or the average of the voltages of the respective acquisition devices may be selected. Then, it is possible to remove such a variation in the acquired voltage.

Meanwhile, when the power acquisition device is moved in the traverse direction (i.e., y-axis) of the road, that is, when a steering deviation occurs, the effective value of the collecting voltage may decrease due to the deviation. If the deviation is small, the width of the acquisition device need be sufficiently increased in order not to decrease the effective value of the acquired voltage. However, if the deviation is too large, the leakage inductance of a power acquisition coil becomes too large, which may cause the decrease of the power acquisition efficiency. Therefore, a proper selection of the width of the acquisition device by trading-off the allowable lateral displacement and the leakage inductance may be necessary.

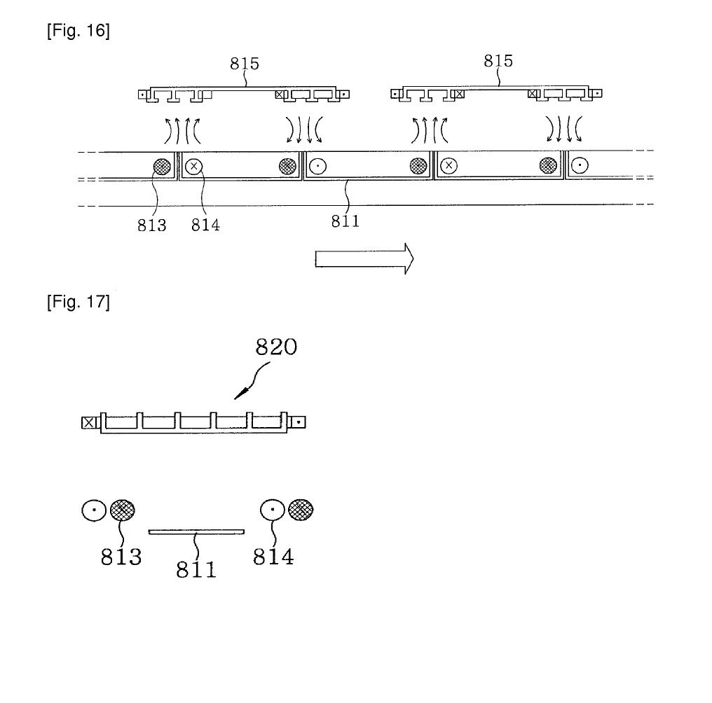

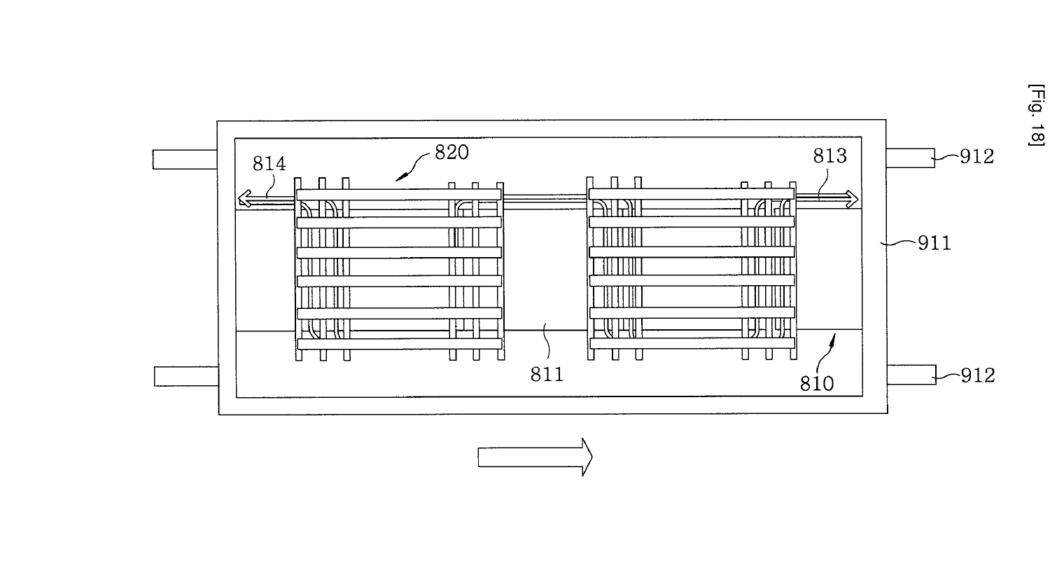

FIGS. 15, 16 and 17 respectively illustrate a plan view, a side view, and a front view of a dual-rail power supply and acquisition apparatus in accordance with another embodiment of the present invention.

The power supply and acquisition apparatus includes a Z-shape power supply device 810 and a power acquisition device 820. The Z-shape power supply device 810 includes a plurality of U-shaped power supply core units 811 and two power supply lines 813 and 814. The power acquisition device 820 includes a plurality of lattice-type power acquisition core units 815. Such a lattice-type power acquisition core unit 815 is advantageous in reducing the weight and in cooling thereof, and may be manufactured in a strong structure.

A distance between the lattices of the power acquisition core unit 815 does not have an effect upon electric performance, as long as the distance is set to ½ or less of the air gap.

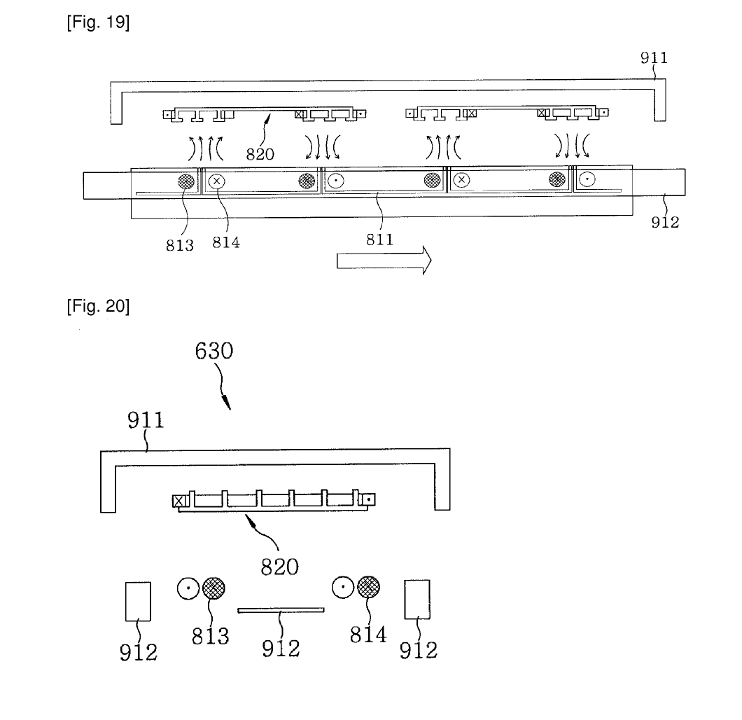

FIGS. 18, 19 and 20 respectively illustrates a plan view, a side view, and a front view of a dual-rail power supply and acquisition apparatus, in which a Z-shaped power supply device and a power acquisition device are magnetically shielded.

In such embodiments as shown in FIGS. 15 to 20, the Z-shaped power supply device has a reduced size to the half of the width of the vehicle, and therefore, has a spatial margin for magnetism shielding. A loop-shaped magnetic shielding 911 is further provided to cover the power acquisition devices 820, so that a leakage magnetic flux is magnetically grounded along a magnetism shielding loop. As a result, the magnetism shielding effect is exhibited. The magnetism shielding member 911 may be provided only along the side surfaces of the power acquisition devices, but provided to cover the entire upper surface of the power acquisition devices.

In addition, a line-shaped magnetism shielding member 912 may be further provided along the power supply device 810, thereby forming a magnetic ground in the longitudinal direction. As a result, the magnetism shielding effect is exhibited to remove an EMF generated in the lateral direction.

Although the above described embodiments of the present invention has been described that the power supply device include U-shaped core units, the power supply and acquisition device may include flat core units or E-shaped power core units as disclosed in the prior art of the present invention.

While the invention has been shown and described with respect to the preferred embodiments, it will be understood by those skilled in the art that various changes and modifications may be made without departing from the scope of the invention as defined in the following claims.

1. A power supply device which supplies power to an electric vehicle using a magnetic induction, the power supply device comprising:
a plurality of power supply core units embedded along a road, each core unit having two magnetic poles spaced from each other and formed in a direction perpendicular to a longitudinal direction of the road; and
one or more power supply lines disposed along the longitudinal direction such that adjacent two magnetic poles of the power supply core units have different polarities.

2. The power supply device of claim 1, wherein, if two power supply lines is provided, the two power supply lines have opposite current directions.

3. The power supply device of claim 1, wherein the power supply lines are covered by a magnetic material.

4. The power supply device of claim 2, wherein one of the power supply lines is extended along one of the magnetic poles of the respective power supply core units and the other power supply line is extended along the other magnetic pole of the respective power supply core units to alternately generate magnetic force lines of different poles in the respective magnetic poles.

5. The power supply device of claim 4, wherein a distance between the two power supply lines is minimized in such a manner that electric field generated in a lateral of the road is minimized.

6. The power supply device of claim 2, wherein the power supply lines connect one end of one of the magnetic poles and the other end of the other magnetic pole of the respective power supply core units in a diagonal direction.

7. The power supply device of claim 2, wherein the one or more power supply lines are wound by several turns around adjacent two magnetic poles of adjacent power supply core units.

8. The power supply device of claim 1, further comprising a line-shaped magnetism shielding member provided along the power supply device.

9. A power acquisition device for an electrical vehicle, which acquires power from a power supply device using a magnetic induction, the power acquisition device comprising:
two or more power acquisition core units installed in the electrical vehicle and spaced from the power supply device;
a connection member for connecting the power acquisition core units such that the power acquisition core units are spaced from each other by a distance between magnetic poles of the power supply device; and
a power acquisition coil wound around the respective power acquisition core units or the connection member.

10. The power acquisition device of claim 9, wherein the power acquisition core units are formed in a plate type.

11. The power acquisition device of claim 9, wherein the power acquisition core units are formed in a lattice type.

12. The power acquisition device of claim 9, further comprising a loop-shaped magnetism shielding member installed around the power acquisition core units.

13. A power supply and acquisition apparatus for an electrical vehicle, comprising:
a power supply device, the power supply device including a plurality of power supply core units embedded along a road, each core unit having two magnetic poles spaced from each other and formed in a direction perpendicular to a longitudinal direction of the road; and one or more power supply lines disposed along the longitudinal direction such that adjacent two magnetic poles of the power supply core units have different polarities; and
a power acquisition device, the power acquisition device including two or more power acquisition core units installed in the electrical vehicle and spaced at a predetermined distance from the power supply device; a connection member for connecting the power acquisition core units such that the power acquisition core units are spaced from each other by a distance between magnetic poles of the power supply device; and
a power acquisition coil wound around the respective power acquisition core units or the connection member.
